(19) United States
(12) Patent Application Publication
(10) Pub. No.: US 2025/0032343 A1
(43) Pub. Date: Jan. 30, 2025

(54) METHOD AND APPARATUS FOR FACILITATING MOBILITY OF USERS

(71) Applicant: Jessa Medical Supply, Inc., Gaithersburg, MD (US)

(72) Inventor: Muse ALIYEV, North Potomac, MD (US)

(21) Appl. No.: 18/773,839

(22) Filed: Jul. 16, 2024

Related U.S. Application Data
(60) Provisional application No. 63/515,610, filed on Jul. 26, 2023.

(51) Int. Cl. A61H 3/04; A61H 3/00

(52) U.S. Cl. CPC A61H 3/04; A61H 2003/007; A61H 2201/0157; A61H 2201/0192; A61H 2201/1609

(57) ABSTRACT

Presented herein are techniques for transporting a mobility device. Each end of a strap is attached to the mobility device to provide an assembly. A middle portion of the strap is provided around a user's neck and/or shoulders. The assembly is lifted via the user's neck and/or shoulders so that an amount of weight of the mobility device is borne by the user's neck and/or shoulders rather than the user's hands or arms.

### CROSS-REFERENCE TO RELATED APPLICATION

This application claims priority to Provisional U.S. Patent Application No. 63/515,610 filed Jul. 26, 2023, the entirety of which is incorporated herein by reference.

### BACKGROUND

### 1. Technical Field

Present invention embodiments relate generally to medical devices, and more specifically, to devices that facilitate the mobility of users.

### 2. Discussion of the Related Art

Mobility devices are specialized equipment designed to aid individuals with limited mobility in maintaining their independence and improving their ability to move and perform daily activities. These devices provide support, stability, and assistance to individuals with various conditions, including but not limited to age-related mobility issues, injuries, disabilities, or chronic illnesses. Examples of mobility devices may include walkers, rollators, wheelchairs, and the like. Given that individuals who use such mobility devices may have chronic pain, limited range of motion, etc., it can be difficult for individuals to perform certain acts with respect to their mobility devices, such as loading a mobility device into a vehicle or otherwise storing a mobility device.

### BRIEF DESCRIPTION OF THE DRAWINGS

Generally, like reference numerals in the various figures are utilized to designate like components.

FIG. 1 is a view in perspective of a mobility device in accordance with an embodiment of the present invention;

FIG. 2A is a view in perspective of a strap in accordance with an embodiment of the present invention;

FIG. 2B is a view in perspective of a strap in accordance with an embodiment of the present invention;

FIG. 3 is a view in perspective of an assembly comprising a mobility device and a strap in accordance with an embodiment of the present invention;

FIG. 4 is a view in elevation of an assembly comprising a mobility device and a strap in accordance with an embodiment of the present invention;

FIGS. 5A-5C are views in elevation of an assembly comprising a mobility device and a strap in accordance with an embodiment of the present invention;

FIG. 6 is a side view in elevation of an assembly comprising a mobility device and a strap in accordance with an embodiment of the present invention;

FIG. 7 is a view in perspective of an assembly comprising a mobility device and a strap in accordance with an embodiment of the present invention;

FIG. 8 is a side view in elevation of an assembly comprising a mobility device and a strap being lifted by a user in accordance with an embodiment of the present invention;

FIG. 9 is a flowchart illustrating a method of lifting a mobility device in accordance with an embodiment of the present invention.

### DETAILED DESCRIPTION

Present invention embodiments relate generally to medical devices, and more specifically, to devices that facilitate the mobility of users. These devices can include wheelchairs, walkers, rollators, and other devices. A wheelchair refers to a mobility device designed to assist individuals with limited or no ability to walk in achieving independent mobility. A wheelchair consists of a frame and features two rear wheels, often powered by hand rims, which enable the user to self-propel, while (typically smaller) front wheels provide stability and maneuverability. In contrast, walkers and rollators are used to provide walking assistance to ambulatory users. A walker is a mobility device designed to assist individuals with impaired balance, stability, or strength in maintaining an upright position and moving independently. Walkers include a frame to provide structural support, which is often collapsible for easy storage and/or transport. Walkers may include four legs with tips that include rubber or other materials for traction; some walkers may include wheels on the front legs rather than tips. Rollators are similar to wheeled walkers, and may include additional features such as brakes for improved maneuverability and/or a seat on which the user may rest. Both walkers and rollators can include various other features, such as handles with grips, storage compartments, and other desired features.

As a user of a mobility device may typically have some sort of impairment that hinders the user's mobility, the user may have difficulty with picking up their mobility device for storage. For example, a user may struggle to place a mobility device into a vehicle. Thus, present embodiments provide an assembly that includes a mobility device (e.g., wheelchair, walker, rollator, etc.) and a strap for the mobility device that enables a user to securely pick up and move their mobility device while maintaining their own safety and stability. In particular, the strap may securely attach to points of the mobility device and can go around a user's shoulder or neck so that the user can bear the weight of the device in a manner that ensures that the user can maintain his or her balance. The strap can be adjustable to accommodate various heights of users, and can include safety features such as padding that provide additional comfort while in use. In various embodiments, the strap may include attachment mechanisms that can accommodate a variety of different mobility devices, and the attachment mechanisms may be configured to attach to a mobility device at points that are selected based on the mobility device's center of gravity in order to achieve stability.

Accordingly, present embodiments enable users with disabilities or users who are of an advanced age to perform actions such as loading their mobility devices into a trunk or backseat of a vehicle in a manner that avoids straining the user's lower back or wrist and does not require a great deal of upper arm strength. Using the strap will enable a user to bend forward, position the strap around the user's neck and/or shoulders so that the user may instead lift the mobility device using muscles such as the upper back muscles, trapezius, rhomboid major muscles, and the like. The user can therefore maintain better balance while handling a mobility device. Accordingly, present embodiments can assist users who have conditions like degenerative osteoarthritis, carpal tunnel syndrome, neuropathy, muscular atrophies, nerve damage, post-stroke deformities, and the like.

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description and appended claims, or may be learned by the practice of embodiments of the invention as set forth hereinafter.

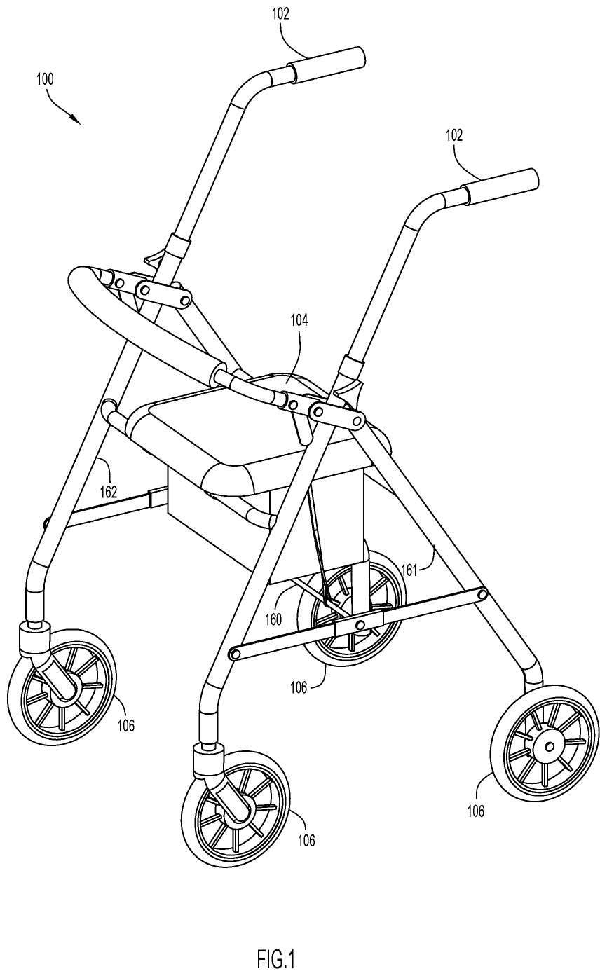

Present invention embodiments will now be described in detail with reference to the Figures. FIG. 1 is a view in perspective of a mobility device 100 in accordance with an embodiment of the present invention. As depicted, mobility device 100 is a rollator that includes handles 102 ascending from the frame, a seat 104 integrated into the frame, and wheels 106; the rollator may be foldable for storage and can include, among other elements in its frame. Mobility device 100 includes a bar 160 that extends transversely between a left portion 161 and a right portion 162 to provide structural support for mobility device 100 by connecting the left portion 161 and the right portion 162, each of which has legs terminating at the wheels 106. It should be appreciated that in various embodiments, mobility device 100 may include a walker, wheelchair, or other mobility device, and the depicted example includes a rollator as a non-limiting example to provide a clear explanation of present embodiments.

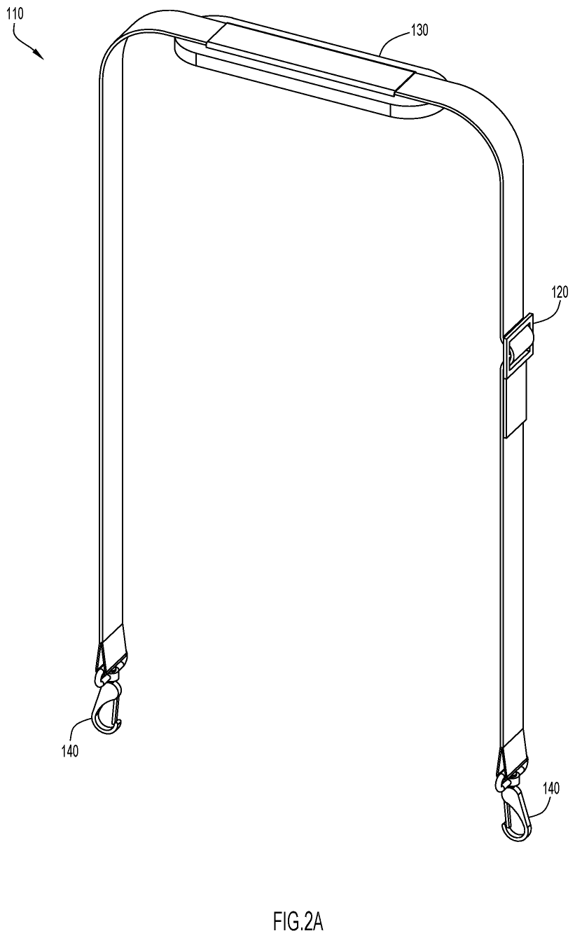

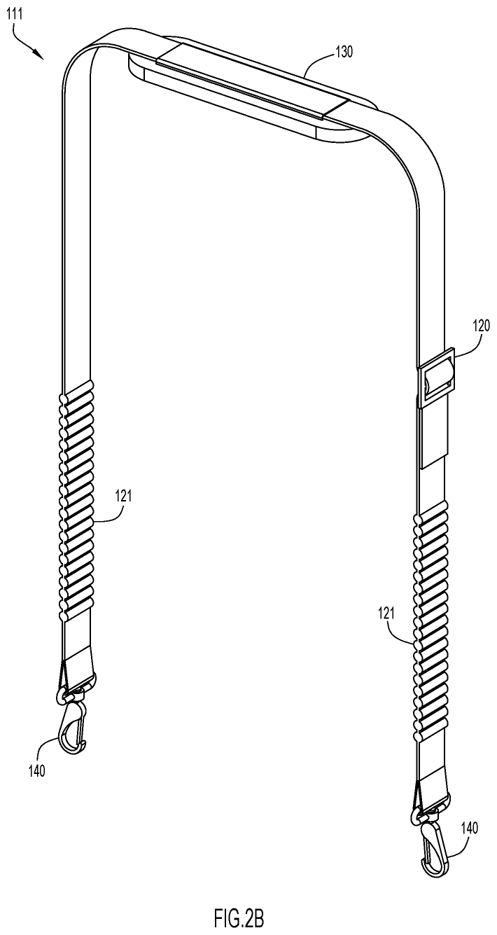

FIG. 2A is a view in perspective of a strap 110 in accordance with an embodiment of the present invention. As depicted, strap 110 includes an adjustment mechanism 120, padding 130, and attachment mechanisms 140. In various alternative embodiments, strap 110 may not include adjustment mechanism 120 and/or padding 130. Adjustment mechanism 120 may include a slider, which can be a rigid component that moves along strap 110, which is threaded through a loop or gap in adjustment mechanism 120. Adjustment mechanism 120 may also include gripping components (e.g., “teeth”) for holding adjustment mechanism 120 in a desired position via friction. By moving adjustment mechanism 120 closer to, or farther from, one end of strap 110, the effective length of strap 110 can be increased or decreased to adjust the length of strap 110 to fit a particular user.

Padding 130 may include a soft material that provides greater comfort to a user at the point of contact between the user's body and strap 110. Padding 130 may include a cushioned section and a channel through which strap 110 may pass, enabling the position of padding 130 to be changed by sliding padding 130 with respect to strap 110. The size and thickness of padding 130 can vary across various embodiments, and the cushioned material of padding 130 may include foam, gel, fabric, or other suitable materials.

Attachment mechanisms 140 may include clips for securing each end of strap 110 to a mobility device. Each attachment mechanism 140 may be provided at an end of strap 110 via a sewn loop (as depicted in FIG. 2) or by another mechanism (e.g., a snap fastener, etc.). Each attachment mechanism 140 may include a clip with a gate that may be opened by applying a force to the gate mechanism (e.g., a spring-biased clip). The gate mechanism can be a hinged bar to which a spring provides bias to cause the gate to remain in the closed position in the absence of force being applied.

FIG. 2B is a view in perspective of a strap 111 in accordance with another embodiment of the present invention. As depicted, strap 111 includes an adjustment mechanism 120, padding 130, attachment mechanisms 140, and elastic portions 121. In various alternative embodiments, strap 111 may not include adjustment mechanism 120 and/or padding 130. Elastic portions 121 may include any elastic material that can stretch to accommodate a user's neck when the user's neck is inserted under strap 111. Elastic portions 121 may include a bungee material, elasticated cord, or other suitable stretchable material, which can be incorporated within one or more other materials (e.g., a rubberized core and a braided outer sheath, etc.). It should be appreciated that any of the embodiments described herein can utilize either of strap 110 or strap 111.

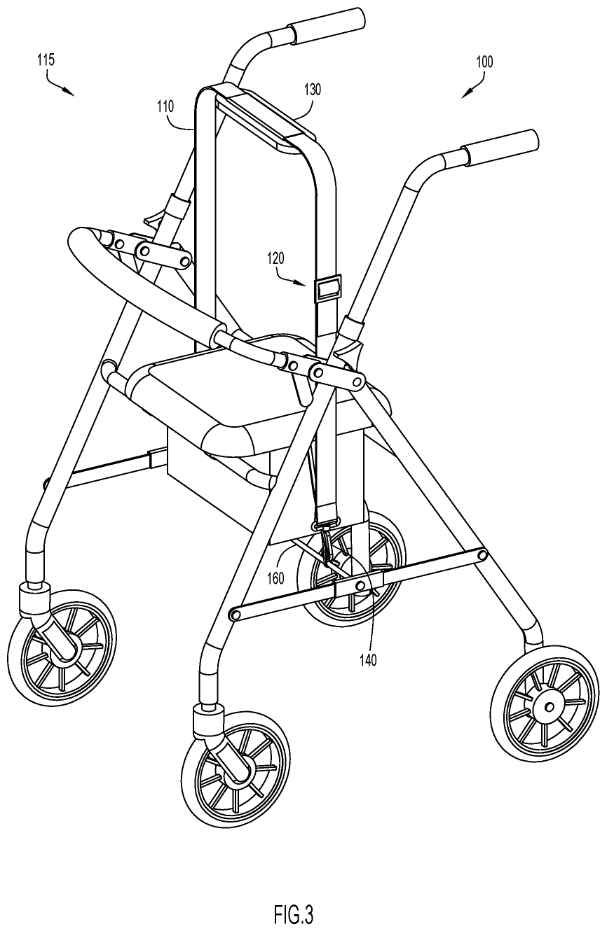

FIG. 3 is a view in perspective of an assembly 115 comprising a mobility device 100 and a strap 110 in accordance with an embodiment of the present invention. As depicted, assembly 115 is formed by attaching strap 110 to mobility device 100 via attachment mechanisms 140. Each attachment mechanism 140 may be secured to a portion of the frame of mobility device 100; in the depicted example, each attachment mechanism 140 is secured to bar 160. Thus, a user may place the user's neck underneath strap 110 in order to facilitate lifting of mobility device 100 via the user's body.

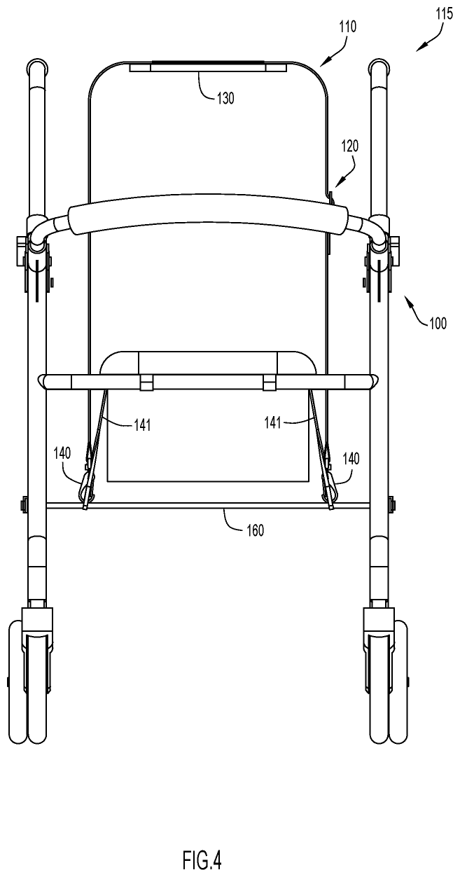

FIG. 4 is a view in elevation of an assembly 115 comprising a mobility device 100 and a strap 110 in accordance with an embodiment of the present invention. As depicted, strap 110 includes padding 130 and adjustment mechanism 120 and attaches to bar 160 via attachment mechanisms 140. Also depicted are members 141 that connect the seat of mobility device 100 to bar 160. Members 141 can serve to hold attachment mechanisms 140 in place on bar 160 (e.g., preventing attachment mechanisms 140 from sliding beyond a threshold distance away from the center of bar 160).

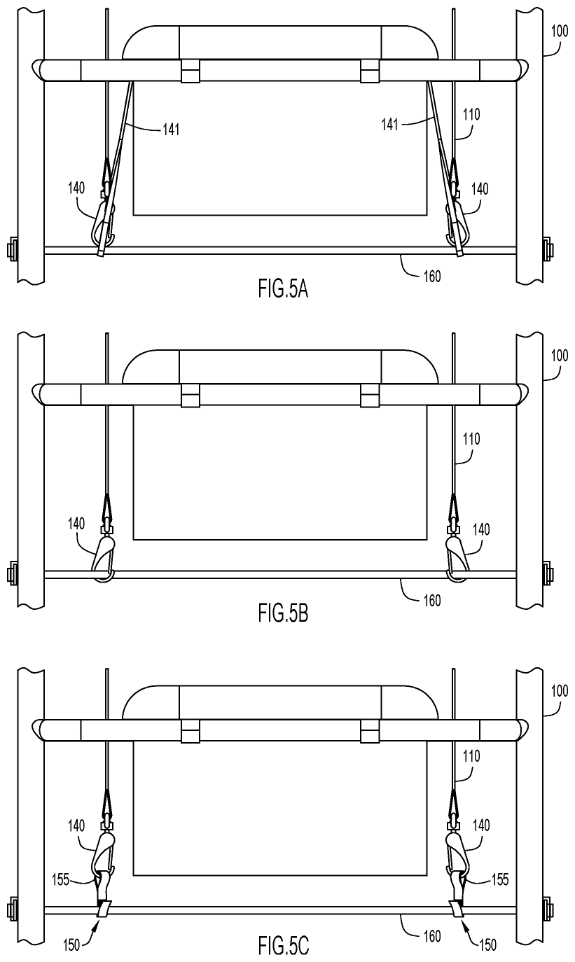

FIGS. 5A-5C are views in elevation of an assembly 115 comprising a mobility device 100 and a strap 110 in accordance with an embodiment of the present invention. With reference now to FIG. 5A, strap 110 is shown with attachment mechanisms 140 adjacent to, but unattached to bar 160. Attachment mechanisms 140 can be attachable at or near the point of contact between bar 160 and members 141 to fix attachment mechanisms 140 in place or to prevent the attachment mechanisms 140 from sliding along bar 160. With reference now to FIG. 5B, a same embodiment is depicted in which attachment mechanisms 140 have been secured to bar 160. With reference to FIG. 5C, another embodiment is provided in which attachment mechanisms 140 attach to attachment straps 155, which may include a hook-and-loop (or other) fastener 150 that attaches to bar 160. Thus, attachment mechanisms 140 can be secured to bar 160 in a manner that prevents lateral sliding of attachment mechanisms 140 during use or storage.

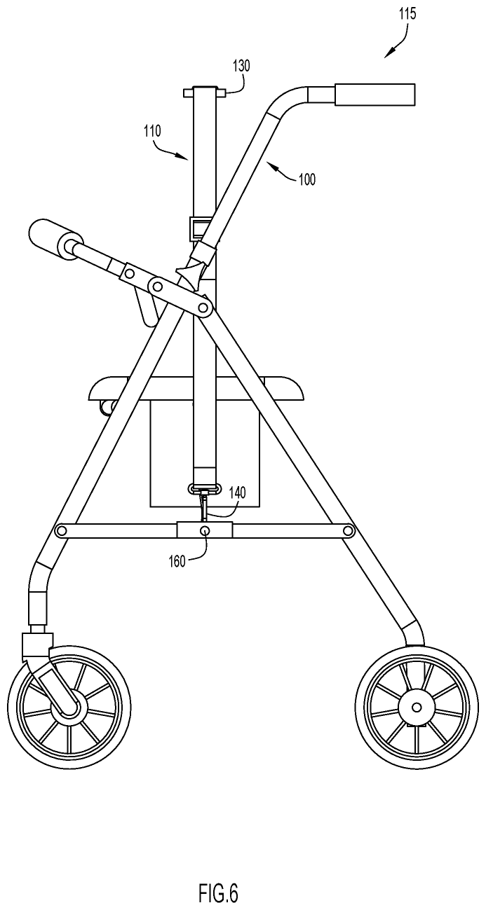

FIG. 6 is a side view in elevation of an assembly 115 comprising a mobility device 100 and a strap 110 in accordance with an embodiment of the present invention. As depicted, strap 110 includes padding 130 and attaches to bar 160 via attachment mechanism 140.

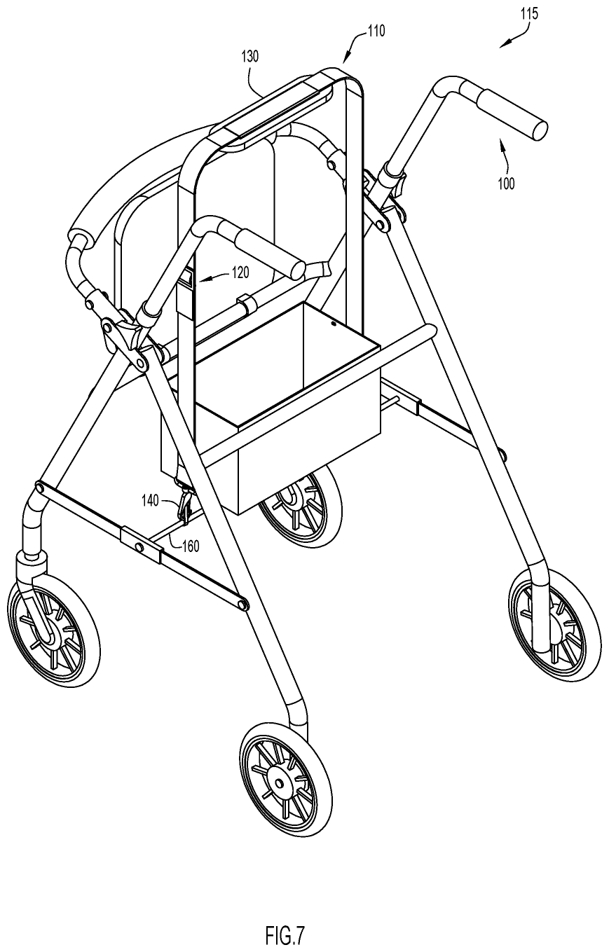

FIG. 7 is a view in perspective of an assembly 115 comprising a mobility device 100 and a strap 110 in accordance with an embodiment of the present invention. As depicted, strap 110 includes padding 130 and adjustment mechanism 120 and attaches to bar 160 via attachment mechanisms 140.

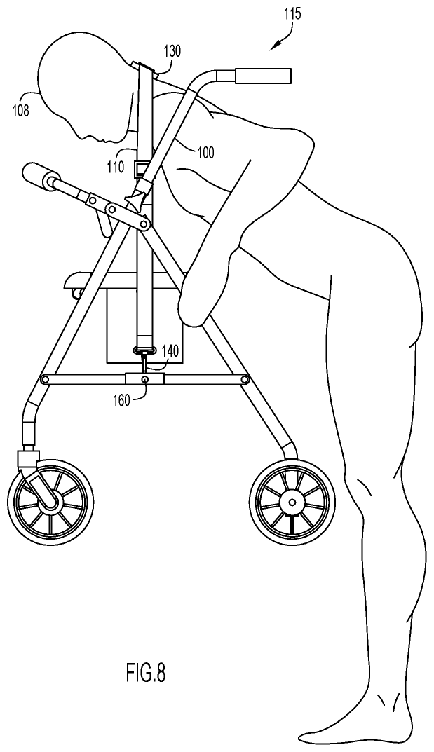

FIG. 8 is a side view in elevation of an assembly 115 comprising a mobility device 100 and a strap 110 being lifted by a user 108 in accordance with an embodiment of the present invention. As depicted, the user 108 can place strap 110 over the back of the user's neck in order to assist the user in lifting the mobility device 100. This configuration provides stability to the user 108, enabling the user 108 to safely pick up the mobility device 100 when the user would otherwise be unable to do so.

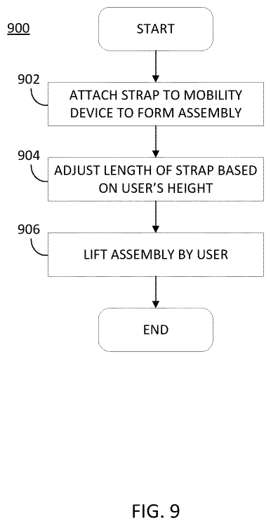

FIG. 9 is a flowchart illustrating a method 900 of lifting a mobility device in accordance with an embodiment of the present invention.

At operation 902, a strap is attached to a mobility device to form an assembly. The strap can be attached to a frame of the mobility device at two points. In particular, the points may be located on a transverse bar that connects one side (e.g., a left side) of a mobility device to another side (e.g., a right side). Each side may have one or more legs that descend and a handle that ascends.

At operation 904, the length of the strap is adjusted based on a user's height. The strap may include one or more adjustment mechanisms that can cause the length of the strap to be increased or decreased.

At operation 906, the assembly is lifted by the user. The user may bend forward and/or pull the strap up toward the user's head and place the strap over the user's neck and/or shoulders. When the user stands upright, the strap will pull the mobility device up, and the user may optionally grip the mobility device with the user's hands to pick the device up. Thus, the assembly can be transported by the user (e.g., placed into a vehicle, etc.). Once repositioned, the user may duck out from under the strap to remove the user from the assembly.

Thus, the embodiments presented herein provide a method for transporting a mobility device by attaching each end of a strap to the device to provide an assembly, providing a middle portion of the strap around a user's neck and/or shoulders, and lifting the assembly via the user's neck and/or shoulders so that an amount of weight of the mobility device is borne by the user's neck and/or shoulders rather than the user's hands or arms. In some embodiments, strap 110 may be configured for storage by joining to mobility device 100 when not in use (e.g., via one or more magnetic elements or one or more hook-and-loop fastener elements embedded in or attached to strap 110 and/or mobility device 100. In some embodiments, strap 110 may include a gap at a portion corresponding to the center of strap 110 so that a user may insert the user's head through strap 110, with elements of strap 110 passing anterior to and posterior to the user's neck, thus providing additional support when a user lifts mobility device 100 via the user's head/neck. In some embodiments, strap 110 may comprise two separate elements that can be joined or separated at a location substantially corresponding to the center of strap 110 when joined, so that a user may apply strap 110 around the posterior of the user's neck to secure strap 110 without the user having to bend down. For example, strap 110 may include a buckle or snap mechanism so that the two portions of strap 110 can be attached together behind a user's neck. In some embodiments, strap 110 may include one or more retractable elements with a braking mechanism and/or spring-loaded retractable system(s) to bias strap 110 at a position closer to mobility device 100 when not in use, and to enable a user to extend strap 110 when in use by applying a tension (e.g., pulling strap 110 away from mobility device 100).

In some aspects, the techniques described herein relate to an assembly including: a mobility device, the mobility device including a frame that includes a left portion, a right portion, a bar connecting the left portion and the right portion, and one or more handles ascending from the frame; and a strap attached to the mobility device at the bar, wherein the strap includes a center portion, a first end, and a second end, wherein the first end of the strap attaches to the bar at a first point between a center of the bar and the left portion, and wherein the second end of the strap attaches to the bar at a second point between the center of the bar and the right portion.

In some aspects, the techniques described herein relate to an assembly, wherein the center portion of the strap includes a padding.

In some aspects, the techniques described herein relate to an assembly, wherein the strap includes one or more adjustment mechanisms configured to adjust a length of the strap.

In some aspects, the techniques described herein relate to an assembly, wherein the strap includes one or more elastic portions.

In some aspects, the techniques described herein relate to an assembly, wherein the mobility device includes a rollator that includes a seat.

In some aspects, the techniques described herein relate to an assembly, wherein the mobility device includes a walker.

In some aspects, the techniques described herein relate to an assembly, wherein a first hook-and-loop fastener is provided at the first point of the bar and a second hook-and-loop fastener is provided at the second point of the bar, wherein the first end of the strap attaches to the bar by connecting to the first hook-and-loop fastener, and wherein the second end of the strap attaches to the bar by connecting to the second hook-and-loop fastener.

In some aspects, the techniques described herein relate to an assembly, wherein a first attachment mechanism and a second attachment mechanism each include a spring-biased clip.

In some aspects, the techniques described herein relate to a method including: attaching a strap to a mobility device to form an assembly, wherein the mobility device includes a frame that includes a left portion, a right portion, a bar connecting the left portion and the right portion, and one or more handles ascending from the frame, wherein the strap includes a center portion, a first end, and a second end, wherein attaching the strap to the mobility device includes attaching the first end of the strap to the bar at a first point between a center of the bar and the left portion, and attaching the second end of the strap to the bar at a second point between the center of the bar and the right portion; and lifting, by a user, the assembly, wherein the user places the strap over a neck or shoulders of the user and raises the neck or shoulders of the user to lift the assembly.

In some aspects, the techniques described herein relate to a method, further including: providing a padding to the center portion of the strap.

In some aspects, the techniques described herein relate to a method, wherein the strap includes one or more adjustment mechanisms configured to adjust a length of the strap.

In some aspects, the techniques described herein relate to a method, further including: adjusting the length of the strap based on a height of the user.

In some aspects, the techniques described herein relate to a method, wherein the strap includes one or more elastic portions.

In some aspects, the techniques described herein relate to a method, further including: providing a first hook-and-loop fastener at the first point of the bar and a second hook-and-loop fastener at the second point of the bar, and wherein attaching the strap to the mobility device includes attaching the first end of the strap to the bar by connecting the first end to the first hook-and-loop fastener, and attaching the second end of the strap to the bar by connecting the second end to the second hook-and-loop fastener.

1. An assembly comprising:
a mobility device, the mobility device comprising a frame that includes a left portion, a right portion, a bar connecting the left portion and the right portion, and one or more handles ascending from the frame; and
a strap attached to the mobility device at the bar, wherein the strap includes a center portion, a first end, and a second end, wherein the first end of the strap attaches to the bar at a first point between a center of the bar and the left portion, and wherein the second end of the strap attaches to the bar at a second point between the center of the bar and the right portion.

2. The assembly of claim 1, wherein the center portion of the strap includes a padding.

3. The assembly of claim 1, wherein the strap includes one or more adjustment mechanisms configured to adjust a length of the strap.

4. The assembly of claim 1, wherein the strap includes one or more elastic portions.

5. The assembly of claim 1, wherein the mobility device comprises a rollator that includes a seat.

6. The assembly of claim 1, wherein the mobility device comprises a walker.

7. The assembly of claim 1, wherein a first hook-and-loop fastener is provided at the first point of the bar and a second hook-and-loop fastener is provided at the second point of the bar, wherein the first end of the strap attaches to the bar by connecting to the first hook-and-loop fastener, and wherein the second end of the strap attaches to the bar by connecting to the second hook-and-loop fastener.

8. The assembly of claim 1, wherein a first attachment mechanism and a second attachment mechanism each comprise a spring-biased clip.

9. A method comprising:
attaching a strap to a mobility device to form an assembly, wherein the mobility device comprises a frame that includes a left portion, a right portion, a bar connecting the left portion and the right portion, and one or more handles ascending from the frame, wherein the strap includes a center portion, a first end, and a second end, wherein attaching the strap to the mobility device comprises attaching the first end of the strap to the bar at a first point between a center of the bar and the left portion, and attaching the second end of the strap to the bar at a second point between the center of the bar and the right portion; and
lifting, by a user, the assembly, wherein the user places the strap over a neck or shoulders of the user and raises the neck or shoulders of the user to lift the assembly.

10. The method of claim 9, further comprising:
providing a padding to the center portion of the strap.

11. The method of claim 9, wherein the strap includes one or more adjustment mechanisms configured to adjust a length of the strap.

12. The method of claim 11, further comprising:
adjusting the length of the strap based on a height of the user.

13. The method of claim 9, wherein the strap includes one or more elastic portions.

14. The method of claim 9, further comprising:
providing a first hook-and-loop fastener at the first point of the bar and a second hook-and-loop fastener at the second point of the bar, and wherein attaching the strap to the mobility device comprises attaching the first end of the strap to the bar by connecting the first end to the first hook-and-loop fastener, and attaching the second end of the strap to the bar by connecting the second end to the second hook-and-loop fastener.
